(19) United States
(12) Patent Application Publication
(10) Pub. No.: US 2001/0046581 A1
(43) Pub. Date: Nov. 29, 2001

(54) Carpet with a polymer layer

(75) Inventors: Julie B. Brumbelow, Dalton, GA (US); Marvin L. Saylors, Cohutta, GA (US); Von L. Moody, Brewton, AL (US)

Correspondence Address: Jacqueline M. Hutter, Esq., NEEDLE & ROSENBERG, P.C., The Candler Building, Suite 1200, 127 Peachtree Street, N.E., Atlanta, GA, 30303-1811, US

(73) Assignee: Shaw Industries, Inc.

(21) Appl. No.: 09/837,122

(22) Filed: Apr. 18, 2001

Related U.S. Application Data
(63) Continuation-in-part of application No. 09/482,897, filed on Jan. 14, 2000.
(63) Continuation-in-part of application No. 09/492,637, filed on Jan. 27, 2000.

(51) Int. Cl. B32B 5/24; B32B 3/02; D04H 11/00; D05C 17/00; D03D 27/00

(52) U.S. Cl. 428/95; 428/85; 442/221

(57) ABSTRACT

The present invention is directed at a carpet which comprises a) yarn tufted into a primary backing, wherein the primary backing has a face side and a back side and wherein the yarn is adhesively attached to the primary backing; b) a woven secondary backing with a first side and a second side wherein the first side is directly or indirectly attached to the back side of the primary backing; and c) a thermoplastic polymer layer adjacent to the second side of the secondary backing, wherein the polymer layer is attached to the secondary backing via melt bonding. The present invention is also directed at a method of manufacturing a carpet including: tufting a yarn into a primary backing, wherein the primary backing has a face side and a back side; adhesively affixing the yarn to the primary backing; providing a woven secondary backing having a first side and a second side; attaching directly or indirectly the first side of the secondary backing to the back side of the primary backing; and applying a thermoplastic polymer layer to the second side of the secondary backing under conditions suitable to melt bond the thermoplastic polymer layer to the secondary backing.

### CROSS-REFERENCE TO RELATED APPLICATIONS

This is a continuation-in-part of U.S. application Ser. No. 09/482,897, filed Jan. 14, 2000, and U.S. application Ser. No. 09/492,637, filed Jan. 27, 2000, both of which are co-pending, wherein the disclosures of each are hereby incorporated by reference.

### FIELD OF THE INVENTION

The present invention relates to a carpet having a thermoplastic polymer-containing layer wherein the carpet backing exhibits decreased friction and decreased moisture permeability and a method for making such a carpet. In particular, the carpet has several layers including a primary backing layer, a secondary backing layer, and the polymer layer.

### BACKGROUND OF THE INVENTION

Finished carpets and carpet tiles are widely used in both residential and commercial properties. Finished carpets include rugs, as well as cut carpets that can be fitted to the desired area.

Finished carpets typically have a number of layers, e.g., a primary backing layer, an adhesive layer, and a secondary backing layer. Carpet is generally produced as tufted carpet where yarn, typically consisting of nylon, polyester, wool or polypropylene, is stitched into a primary backing that is woven from a polypropylene slit film. Typically, the primary backing material provides a woven web of polypropylene in which to stitch the fiber material. The majority of carpets are then coated with a polymeric adhesive, which may consist of, but is not limited to, styrene butadiene latex compound or a urethane compound. The carpet may or may not have a secondary backing which is usually a woven polypropylene with a slit film warp yarn and a spun or filament polypropylene fill yarn. The secondary backing may create a rough surface on the back of the carpet. The primary backing material is bonded to the secondary backing material, typically by way of a polymeric adhesive layer.

Carpets having such backings are typically cut to fit the installation and attached with seaming tape as necessary and then are installed over cushion material or are glued directly to the subfloor using multipurpose adhesives. The carpet may also be glued to the cushion or underlayment which is in turn glued to the subfloor. In each of these installation techniques, the carpet is stretched as it is installed using one of two stretching devices, a power stretcher or a knee kicker.

Carpet as it is currently produced may cause damage during the installation by the scuffing of walls, doors, furniture and baseboards. As the installation is conducted, the carpet is generally cut to fit a room and is manipulated within the room until it fits against the baseboards so that the carpet may be trimmed to fit against the wall. In the process of this manipulation, the baseboard, wall and/or doors are often scraped removing paint and leaving scars that must be repaired. This damage must be repaired, often at great cost to the installation technicians, the dealer or contractor, and/or the consumer. The roughness or scratchy surface of the carpet's backing also can cause difficulty for the installer to manipulate the carpet, thus making the likelihood of damage greater. A less abrasive backing would make handling easier during the installation and greatly reduce the likelihood of damage to the walls, doors and baseboards.

Another problem with finished carpets is that liquid spilled onto the carpet can flow immediately through the carpet and into the cushion material or the floor. Carpet as it is typically manufactured, utilizing a backing of polymeric adhesive and a woven secondary backing, will not provide a barrier to retain spills of beverages or other liquids, such as pet urine. A liquid will pass through to the underlayment cushion or floor whereby removing the liquid becomes difficult, if not impossible. This can lead to the formation of odors, stains, growth and entrapment of bacteria and other potentially carpet damaging conditions.

One attempt to solve the problem of liquid spills is presented in U.S. Pat. No. 5,612,113. This patent requires a liquid impervious thermoplastic film material to be adhesively bonded to the primary or secondary backing material. This technique requires extra steps and equipment, in addition to the expense of a separate adhesive.

Another attempt to address the problem of carpet spills is set forth in U.S. Pat. No. 5,800,898. This patent discloses a tufted carpet with a polymer layer. The carpet is comprised consecutively of a primary backing, polyolefin locking layer, the moisture barrier polyolefin layer and a secondary backing.

The backing systems disclosed in these two patents are considerably more expensive than standard backing systems utilized in the production of carpets. To date, the average carpet consumer has not shown a willingness to pay the additional cost of these more fully impervious backing systems.

In spite of the foregoing, the need still exists for an improved carpet capable of addressing the above-discussed problems, in particular, carpets that may be able to address both problems.

### SUMMARY OF THE INVENTION

The present invention relates to a carpet which comprises a) yarn tufted into a primary backing, wherein the primary backing has a face side and a back side and wherein the yarn is adhesively attached to the primary backing; b) a woven secondary backing with a first side and a second side wherein the first side is directly or indirectly attached to the back side of the primary backing; and c) a thermoplastic polymer layer adjacent to the second side of the secondary backing, wherein the polymer layer is attached to the secondary backing via melt bonding.

The present invention is also directed at a method of manufacturing a carpet including: tufting a yarn into a primary backing, wherein the primary backing has a face side and a back side; adhesively affixing the yarn to the primary backing; providing a woven secondary backing having a first side and a second side; attaching directly or indirectly the first side of the secondary backing to the back side of the primary backing; and applying a thermoplastic polymer layer to the second side of the secondary backing under conditions suitable to melt bond the thermoplastic polymer layer to the secondary backing.

Advantages of the invention will be apparent from the description, or may be learned by practice of the invention. Additional advantages of the invention will be realized and attained by means of the elements and combinations particularly pointed out in the appended claims. It is to be understood that both the foregoing general description and the following detailed description are exemplary and explanatory only and are not restrictive of the invention, as claimed.

The accompanying drawings, which are incorporated in and constitute a part of this specification, illustrate several aspects of the invention and together with the description, serve to explain the principles of the invention.

### BRIEF DESCRIPTION OF THE DRAWINGS

The above summary, as well as further aspects, features and advantages of the present invention will be more fully appreciated by reference to the following brief description of illustrative aspects in accordance with the present invention when taken in conjunction with the accompanying drawings wherein:

FIG. 1 is a cross-sectional view depicting an aspect of the carpet of the present invention;

FIG. 2 is a process diagram depicting a method of contacting a surface of the secondary backing with a polymer extrusion melt; and

FIG. 3 is a process diagram depicting another method of contacting a surface of the secondary backing with a polymer film and using a drum laminator to bond the polymer layer to the secondary backing using heat.

### DETAILED DESCRIPTION OF THE INVENTION

The present invention may be understood more readily by reference to the Figures and their previous and following descriptions. Before the present invention is disclosed and described, it is to be understood that the terminology used herein is for the purpose of describing particular aspects only and is not intended to be limiting.

“Melt bond”, or “melt bonding”, as used in this specification and the following claims, refers to a mechanical bond created by a melt of a first material which binds the first material to a second material. When a polymer layer is melt bonded to a secondary backing according to the invention herein, no separate adhesive is needed to attach the polymer layer to the secondary backing.

The present invention relates to a carpet which comprises a) yarn tufted into a primary backing, wherein the primary backing has a face side and a back side and wherein the yarn is adhesively attached to the primary backing; b) a woven secondary backing with a first side and a second side wherein the first side is directly or indirectly attached to the back side of the primary backing; and c) a thermoplastic polymer layer adjacent to the second side of the secondary backing, wherein the polymer layer is attached to the secondary backing via melt bonding.

While carpets comprise one aspect of the invention, the arrangement of layers associated with the present invention also applies to carpet tiles.

The primary backing layer typically comprises any material recognized in the art for use as a carpet backing. The primary backing has a face side and a back side. Specific examples of materials for primary carpet backings are typically woven or nonwoven fabrics made from one or more of natural or synthetic fibers or yarns including jute, wool, polypropylene, polyethylene, polyamide, polyesters, rayon, or various copolymers.

The fibers extending from the face side (which make up the carpet face) of the primary backing material can be made with uncut yarn loops, cut yarn loops (a pile of single yarns), and a mixture of cut and uncut yarns. The fibers (yarn) can be made from wool, cotton, nylon, acrylic, polytrimethylenetheraphthalate, polyester, polypropylene and blends thereof. As the fiber material is not critical, other fiber material would be readily apparent to one of skill in the art, i.e., any material recognized in the art for use as a carpet fiber. The fibers can be treated with suitable colorants, e.g., dye, either before or after fixing the fibers to the primary backing layer. The choice of the fiber materials can affect the subsequent layer selections, especially the suitability of any adhesives.

A tufting method can be used to fix fibers to the primary backing material. However, the present invention may employ any suitable method of fixing the fibers to the primary backing material. For example, fusion bonding may be a suitable alternative to tufting.

The fibers (yarn) are tufted into and adhesively affixed to the primary backing. The adhesive which anchors the yarn can also be useful to adhere additional layers, such as the secondary backing to the back side of the primary backing. Alternatively, a separate adhesive layer may be used to attach the secondary backing to the primary backing than the adhesive layer used to affix the yarn to the primary backing. Examples of suitable adhesives include latexes (such as styrene butadiene latex), polyethylene and other polyolefins, ethylene acrylic acid, carboxylated SBR, ethylene vinyl acetate (EVA) emulsions, hot melts, polyvinyl chloride (PVC), urethane compounds (such as polyurethane), and mixtures of various compounds. Other suitable adhesives would be readily apparent to one of skill in the art.

In one aspect, the adhesive is not extruded onto the back of the primary backing. In another aspect, the adhesive does not comprise an adhesive that would be recognized as a “hot melt” material. Such materials are described generally in U.S. Pat. No. 3, 940,525, the disclosure of which is incorporated herein in its entirety. Such hot melt materials are, in one aspect, expressly excluded from this invention.

In another aspect, the adhesive does not comprise substantially linear ethylene polymers (SLEP) or homogeneously branched linear ethylene polymers (HBLEP). In a further aspect, the adhesive may comprise SLEP and/or HBLEP. SLEP and HBLEP are described in detail in U.S. patent application Ser. No. 09/715,500, the disclosure of which is incorporated herein in its entirety.

The carpet can include optional intermediate layers between the back side of the primary backing and the first side of the secondary backing. The intermediate layer(s) can be adhesively attached to the primary and/or secondary backing. For example, the intermediate layer can strengthen the carpet, pad the carpet and/or minimize fuzzing of the carpet. Additionally, the intermediate layer can stabilize the carpet by counteracting tension applied to the primary layer when the carpet is stretched. The intermediate layer can, for example, include metal stabilizer mesh, foam, fiberglass, or combinations of these materials. Any additional suitable alternative intermediate layers may be readily apparent to one of ordinary skill in the art. In one aspect, the intermediate layer(s) do not contain an extruded thermoplastic polymer that substantially penetrates the primary backing layer.

The secondary backing has a first side and a second side. The first side is oriented toward the back side of the primary backing and is directly or indirectly attached to the back side of the primary backing. If directly attached, the secondary backing will be, either adhesively or otherwise, attached to the primary backing. If indirectly attached, the primary backing will be attached to an intermediate layer and the intermediate layer will be attached to the secondary layer. The secondary backing can be made of a variety of materials. These materials include those of which primary backings are comprised, typically woven or nonwoven fabrics made from one or more of natural or synthetic fibers or yarns including jute, wool, polypropylene, polyethylene, polyamide, polyesters, rayon and various copolymers. Other materials for the secondary backing layers include Action Bac® (Amoco, Naperville, Ill.) products, as well as needle-punched products.

The carpet also includes a thermoplastic polymer layer. The polymer layer is adjacent to the second side of the secondary backing. In accordance with the invention herein, it is critical that the polymer layer be melt-bonded to the secondary backing. Thus, a separate adhesive layer for the polymer layer is not needed. The Applicants herein have found that the thermoplastic polymer layer both reduces moisture permeability through the carpet and increases the smoothness of the carpet backing.

The polymer layer may comprise one or more thermoplastic polymers, which can be any thermoplastic polymer known in the art. Specific examples of suitable polymers include styrene butadiene latex compounds, acrylic modified styrene butadiene compounds, urethane compounds, polyvinyl chloride, ultra low density polyethylenes (ULDPE), low density polyethylenes (LDPE), medium density polyethylenes (MDPE), high density polyethylenes (HDPE), ultra low density polyethylenes (ULDPE), SLEP, HBLEP, ethylene acrylic acid copolymer, ethylene ethyl acrylate copolymer, polystyrene, polypropylene, polyester, polybutylene, polyamide, polycarbonate, rubbers, ethylene propylene polymers, ethylene styrene polymers, styrene block copolymers, vulcanates, vinyl acetate ethylene, and combinations of these polymers.

In one aspect, the polymer layer does not comprise isotactic polypropylene. In a further aspect, the polymer layer does not comprise SLEP or HBLEP.

The polymer layer can include, in addition to the polymer(s), one or more additives, such as, flame retardants (including calcium carbonate, magnesium carbonate, and aluminum tri-hydrate), antioxidants, antimicrobials, smoke suppressants, wetting agents, frothing aids, and other trace elements. Such materials may also be present elsewhere in the carpet, e.g., in or near the primary backing or in or near any intermediate layer.

Still further, the polymer layer may comprise two or more thermoplastic polymers. In this aspect, the melt indices of the polymers may be the same or different.

The thermoplastic polymer(s) can be present in the polymer layer in an amount greater than about 50% by weight. In one aspect of the invention, the polymer comprises about 80% by weight of the polymer layer composition, with the balance being additives. The additives are generally present in effective amounts, such as up to, e.g., about 600 pph for polymer strengthers and about 250 pph for flame retardants, where pph is parts of additive per hundred dry parts of polymer. However, additives may also be absent, or reduced in amount, from the polymer layer, such as in the case of rugs, to lend the carpet more flexibility.

In one aspect of the present invention, the carpet of the present invention does not comprise 100% recyclable materials. For example, the adhesive utilized to attach the yarn to the primary backing may be a latex material.

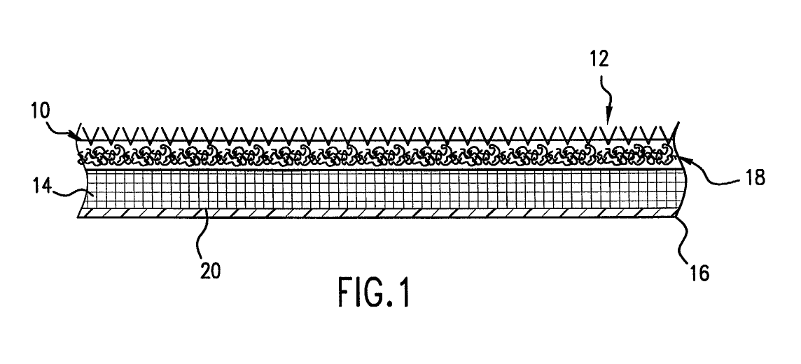

Reference is now made to one aspect of the invention illustrated by FIG. 1 of the drawings. In FIG. 1, the carpet has a primary backing layer [10] with a tufted pile of fibers [12], a woven secondary backing layer [14], and a thermoplastic polymer layer [16]. The primary backing layer [10] and the secondary backing layer [14] are joined together using a polymeric adhesive [18]. The polymer layer [16] is bonded to the bottom of the secondary backing layer [20] via melt bonding.

Although FIG. 1 depicts the polymer layer [16] as a single layer, multiple polymer layers may be used. In such an aspect, each polymer layer may be comprised of at least one thermoplastic polymer. The thermoplastic polymer and optional additives for the thermoplastic polymer layer are described above.

In another aspect of the invention, between the primary backing layer and the woven secondary layer are two layers of polyurethane adhesive with a layer of fiberglass scrim sandwiched between the adhesive layers. The materials of construction of the primary backing layer, woven secondary layer, adhesive layer and polymer layer may be any material previously described. The fiberglass may operate to reduce movement of the carpet from stress, moisture and wear. The fiberglass may be a woven or a non-woven product.

The present invention is also directed at a method of manufacturing a carpet comprising: tufting a yarn into a primary backing, wherein the primary backing has a face side and a back side; adhesively affixing the yarn to the primary backing; providing a woven secondary backing having a first side and a second side; attaching directly or indirectly the first side of the secondary backing to the back side of the primary backing; and applying a thermoplastic polymer layer to the second side of the secondary backing under conditions suitable to melt bond the thermoplastic polymer layer to the secondary backing.

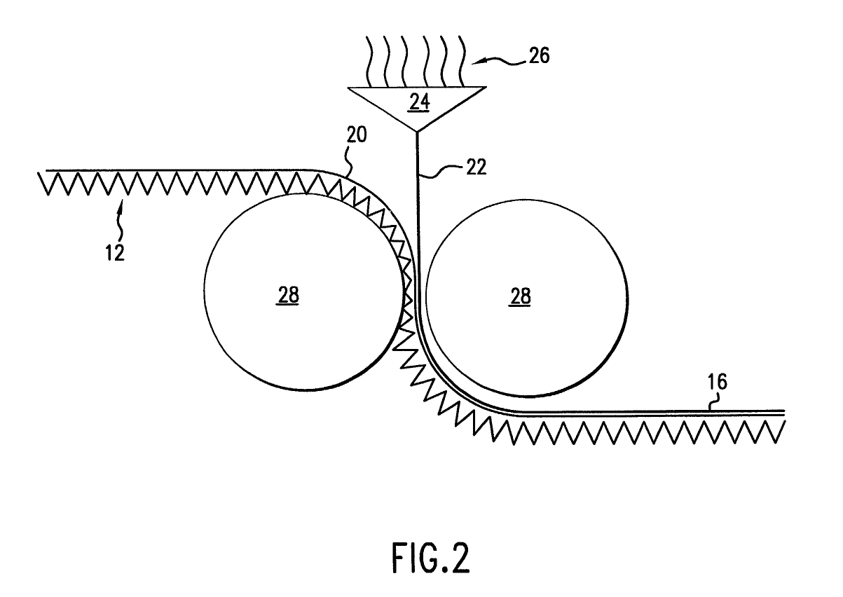

FIG. 2 illustrates one aspect of the above method where the second (outer) surface of the secondary backing layer [20] is contacted with a polymer melt/extrudate [22] from an extrusion die [24]. Polymer material feedstock [26] is fed to the extruder (not depicted) and the extrudate [22] is contacted with the second side of the secondary backing [20]. Cooling and press rolls [28] can be used in conjunction with the extrusion to form the polymer layer [16] bonded to the second side of the secondary backing [20].

The polymer melt is comprised of one or more of the previously described thermoplastic polymers. In addition, the melt may contain other suitable additives as described above.

The thermoplastic polymer can also be applied at about 0.5 to 10 ounces by weight per square yard of the carpet. The specific amount range of polymer applied can be any amount that causes the carpet to exhibit the desired characteristics of increased resistance to moisture permeability and decreased coefficient of friction. To this end, in one aspect, upper portions of the range, e.g., about 4 to 10 including 5, 6, 7, 8, and 9, or a layer of about 10-20 ounces by weight per square yard of carpet including 11, 12, 13, 14, 15, 16, 17, 18 and 19 ounces per square yard of carpet, can be useful to reduce moisture penetration, while the lower portions of the range, e.g., about 0.5 to 4, including 1, 2, 3, and 4 ounces per square yard of carpet, and in another aspect, may be used to reduce the abrasiveness of the carpet backing material. While the optimum amount of polymer layer will depend somewhat upon the characteristics of the secondary backing, in one aspect, it is useful that enough polymer layer is applied so that any surface roughness in the secondary backing is not manifested in the polymer layer.

The processing equipment can include an extrusion die [24], which may be a coat hanger type die or another suitable die for use in a manual or automated extrusion system. Additional processing equipment can include a cooling/press setup [28]. This allows lamination to occur as the polymer is solidified or cooled. Such processing equipment is known in the art and need not be described in detail here.

The temperature of the polymer melt should be controlled so that the melt is hot enough to bond to the secondary backing layer but not too hot so as to result in depressions in the finished surface or melt the other layers of the carpet. Such depressions will generally increase the coefficient of friction of the polymer layer. Although the proper temperature is highly equipment and polymer type dependent, Applicants have found a melt temperature between about 400 and 550° F. to be particularly useful. One of ordinary skill would be able to determine the appropriate temperature to achieve the desired characteristics.

As with the melt temperature, the chill roll temperature is equipment and polymer dependent. It has been found that a chill roll temperature of about 40 to 80° F. is useful to cool the polymer melt. Other chill roll temperatures may also be used depending on the speed of solidification that is needed for bonding the polymer melt to the carpet. One of ordinary skill would be able to determine an effective temperature.

The pressure of the cooling/press rollers is that required to effectuate the bonding. Applicants found that from about 20 to 80 psi, depending on the amount of penetration needed for lamination to occur, has been effective. One of ordinary skill would be able to determine effective pressure conditions.

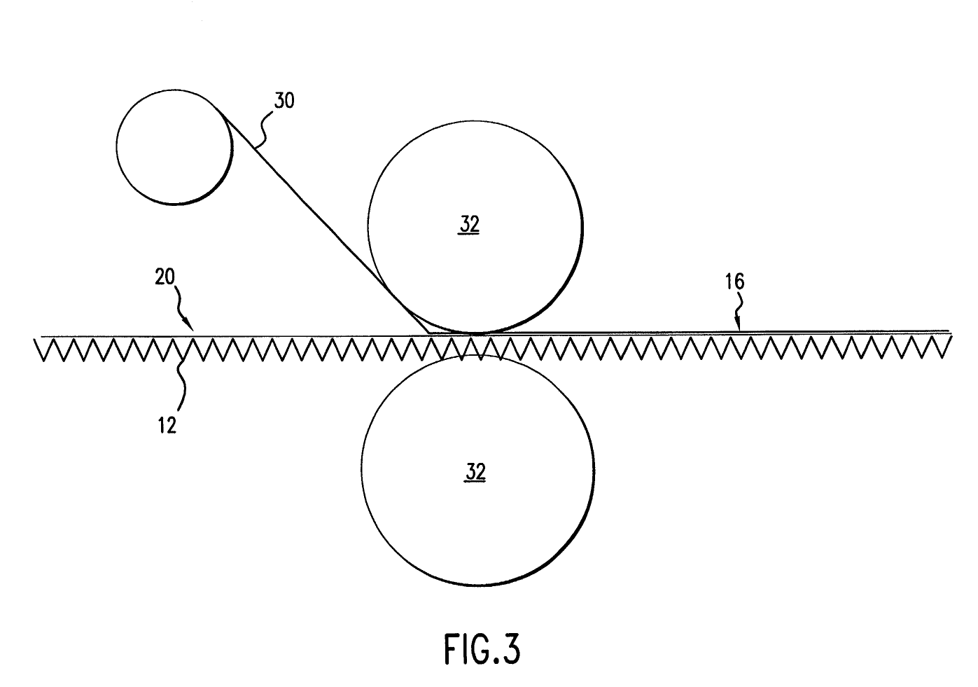

The process depicted in FIG. 3 shows another aspect of the above method where the second side (bottom surface) of the secondary backing layer [20] is contacted with a polymer layer [16] that is applied in the form of a film [30]. The polymer layer [16] may be comprised of one layer of film. Also, the polymer layer can be comprised of two or more layers of film, one with a lower melt temperature than the other(s). The lower melt temperature polymer may be adjacent to the second side of the secondary backing [20] so that the polymer layer [16] bonds to the second side of the secondary backing [20] by passing the carpet and the polymer film [30] through a suitable device, such as a drum laminator [32]. A drum laminator [32] may be used to melt-bond the polymer layer [16] to the finished carpet with the application of heat.

In one aspect, a drum laminator [32] is used to bond the polymer layer [16] to the second side of the secondary backing [20] when the polymer layer is in the form of a polymer film. A temperature of the drum laminator [32] that has been found to be effective with a coextruded 2-layered polyethylene film was 250° F. Suitable alternatives to the drum laminator, which use heat to bond the polymer layer to the carpet, include a powder coating process. Both drum lamination and powder coating processes are known in the art. Other bonding processes may be readily apparent to one of skill in the art.

Temperature and/or pressure conditions effective with a film applied polymer layer can be determined by one of ordinary skill in the art.

A significant advantage that can be associated with the present invention relates to the relatively smooth surface which the polymer layer imparts to the carpet backing. This less abrasive backing surface can minimize, or even eliminate, damage to walls, doors, furniture and baseboards during installation.

This result was surprising based on the disclosure of at least one reference. U.S. Pat. No. 3,940,525 (Ballard) discloses a tufted carpet having a polyolefin film as the secondary backing. Column 4, lines 9-12 indicate that use of a copolymer film increased the coefficient of friction on the back of the carpet thereby rendering it with higher control of slip characteristics. By contrast, the polymer layer of the present invention (which does not serve as the secondary backing, but is, instead, melt-bonded to the secondary backing) reduces the friction as indicated below in the Experimental section.

Another significant advantage that can be produced by the present invention relates to the decreased permeability to moisture. The polymer layer can create a cost-effective moisture barrier which significantly reduces the rate of moisture penetration thereby minimizing the amount of spilled liquid that penetrates through the carpet to the cushion material and/or the subfloor. Thus, spilled liquids are more easily cleaned from the carpet of the present invention.

While carpets are one aspect, the present invention can also be applied to carpet tiles. Manufacturing of carpet tiles may be by any method generally recognized in the art, for example, by the method disclosed in U.S. Pat. No. 5,324,562.

Experimental

The following examples are put forth so as to provide those of ordinary skill in the art with a complete disclosure and description of how the methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° F. or is at ambient temperature, and pressure is at or near atmospheric.

### EXAMPLE 1

### Mechanical Characteristics

Installation Seaming

The carpet was tested at the seams to determine seam strength. The carpets were seamed using a hot melt tape that was heated with a seaming iron. The back of the carpet was laid into the molten hot melt on the seaming tape. As the hot melt was allowed to cool, a carpet seam was created.

NA594 LDPE and NA598 LDPE (Dow Chemical Company, Freeport, Tex.) had a polymer layer that contained a low density polyethylene thermoplastic polymer with a nylon and polyester mix face. Dow INSITE™ comprises a SLEP. Action Bac® Control is a commercially available carpet with a primary backing layer and a conventional secondary backing layer, but without a polymer layer.

| | Average Breaking |
|---|---|
| Polymer tested | Strength at Seam |
| NA594 LDPE | 130 psi |
| NA598 LDPE | 117 psi |
| DOW INSITE ™ 59400 | 116 psi |
| ACTION BAC ™ CONTROL | 136 psi |

These results indicate that the seam strengths of the carpet with melt bonded polymer layers were comparable to the Action Bac® Control.

Delamination, Tuft Bind and Flammability

Delamination, tuft bind and flammability were also tested to be certain that the thermoplastic layer did not have a detrimental effect on any of these properties. Test results indicated that there was no change in the delamination, tuft bind or pill-test flammability properties from any of the thermoplastic layer carpets that were tested.

### EXAMPLE 2

Static Friction

A static friction test was used to test the friction characteristics of the backing. In this test, a platform was installed on a tensile testing apparatus (Instron, Canton, Mass.) so that it was level. Double stick tape or clips were placed on the platform to secure a first piece of the carpet being tested. The carpet was placed so that the face was against the platform with the backing side up. A sled was placed so that it had a 2.5″×10″ flat surface of a second piece of the test sample (on top of the first piece of test sample) with a 5 lb. lead weight placed on top of the sled. The two carpet samples were placed back to back (polymer layer sides touching). A cable was connected to the load cell and to the sled by placing the pin from the top grips through the loop of the cable. The cable was then attached to the carpet sample. The crosshead speed used was 10+/−1 inches per minute on the manual setting.

The test was stopped once the sample was within 1+/−0.5 inches of the pulley. The amount of force to pull the carpet across the back of the other carpet was measured and the highest reading in pounds of force for each pull was reported. A lower coefficient of friction correlates to a less abrasive back which will be less damaging to walls, doors, furniture and baseboards during installation.

The carpet included a nylon face, primary backing, SBR layer, ActionBac®, and a polymer layer of low density polyethylene.

| Weight of Polymer Layer | Coefficient of Friction |
|---|---|
| ounces per square yard | lb Force |
| 2.9 | 3.5 |
| 5 | 3.3 |
| 5.3 | 3.4 |
| 5.9 | 3.3 |
| 7.2 | 2.9 |
| 15.5 | 3 |
| None | 4.25 |

The results indicate that carpets with a melt bonded polymer layer exhibited a lower coefficient of friction than the comparative carpet without a polymer layer.

### EXAMPLE 3

Permeability to Moisture

Moisture permeability was tested on carpets with the polymer layer. A carpet sample was suspended on a wire rack so that any penetration through the back of carpet could be observed and timed. A funnel was placed on a stable rod holder and the center of the funnel is placed over the test specimen at 1 meter of height over the sample. Red dye 40 solution was poured slowly through the funnel with a 10 mm spout onto the carpet, concentrating the solution in one central area on the carpet, if possible. The samples were allowed to sit on the wire rack for 24 hours undisturbed.

This test was conducted on a carpets with a polymer layer and layers of urethane and ActionBac®, as well as the Action Bac® Control. The polymer layer was comprised of a low density polyethylene.

| Weight of Polymer Layer | Liquid | Time for | Penetration of |
|---|---|---|---|
| (ounces per sq. yard) | Applied | Penetration | Polymer Layer |
| None - Action Bac ® | 100 ml | Instantly | Total Saturation of |
| Control | | | towels |
| 2 | 100 ml | None after | None |
| | | 24 hours | |
| 2 | 200 ml | 1 minute | Very slight wicking |
| | | | action; Most liquid |
| | | | retained on surface |

These results indicate that the melt bonded polymer layer decreases moisture permeability.

### EXAMPLE 4

Moisture Impact

In this test, a 9 inch×9 inch square piece of carpet was cut and placed on a white absorbent paper towel that was a 8 inch×8 inch square. The carpet with the paper towel beneath it was laid in a specimen tray and centered underneath a presser foot on the moisture penetration machine. The carpet overlapped the specimen tray approximately ¼ inch on all sides. A cup with 20 ml of staining solution was applied to the carpet by pouring the fluid into the application funnel. This funnel had a hose attached to the bottom and the fluid passed through the funnel into the hose and into a ring and onto the carpet.

When the machine was turned on, the tray containing the carpet sample was lifted into the presser foot so that 20 psi was applied to the wet carpet. Each contact is counted as one cycle. The paper towel underneath the carpet sample was checked for moisture penetration in increments of 100 cycles for the first 1000 cycles. The carpet was considered to have allowed moisture to penetrate when any evidence of staining agent is visible on the paper towel with the unaided eye. The test was continued by checking at increments of 1000 cycles until penetration occurred or the test was terminated, usually at 10,000 cycles.

Throughout the test the carpet was checked to be certain that it was still wet. If the carpet was dry, additional staining solution was added in the same manner as at the beginning of the test.

The polymer layer, which consisted of a low density polyethylene, was added to carpets which had differing secondary backings or no secondary backing at all.

| Weight of Polymer Layer | Secondary | Cycles Before |
|---|---|---|
| (ounces per sq. yard) | Backing | Penetration |
| 6.6 | Action Bac ® | 10,000 |
| 5 | Action Bac ® | 10,000 |
| None | Action Bac ® | 0 |
| None | None | 0 |

These results indicate that the melt bonded polymer layer decreases moisture penetration through the carpet.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

We claim:

1. A carpet comprising
a) yarn tufted into a primary backing, wherein the primary backing has a face side and a back side and wherein the yarn is adhesively attached to the primary backing with an adhesive;
b) a woven secondary backing having a first side and a second side, wherein the first side is directly or indirectly attached to the back side of the primary backing; and
c) a thermoplastic polymer layer adjacent to the second side of the secondary backing, wherein the polymer layer is attached to the secondary backing via melt bonding.

2. The carpet of claim 1, wherein the carpet exhibits reduced permeability to moisture, as compared to a carpet not having the thermoplastic polymer layer.

3. The carpet of claim 1, wherein the carpet exhibits a decreased coefficient of friction on a side opposite the yarn, as compared to a carpet not having the thermoplastic polymer layer.

4. The carpet of claim 1, wherein the yarn comprises one or more of: wool, cotton, nylon, acrylic, polytrimethylenetheraphthalate, polyester, or polypropylene.

5. The carpet of claim 1, wherein the adhesive comprises one or more of: latex, polyethylene, ethylene acrylic acid, carboxylated SBR, ethylene vinyl acetate (EVA), polyvinyl chloride (PVC), or polyurethane.

6. The carpet of claim 1, wherein the adhesive does not comprise a hot melt.

7. The carpet of claim 1, wherein the primary backing comprises one or more of: jute, wool, polypropylene, polyethylene, polyamide, polyesters, or rayon.

8. The carpet of claim 1 further comprising an intermediate layer which comprises one or more of: fiberglass, foam, or metal mesh, wherein the intermediate layer is oriented adjacent to the back side of the primary backing and the first side of the secondary backing.

9. The carpet of claim 1, wherein the secondary backing comprises one or more of: jute, wool, polypropylene, polyethylene, polyamide, polyester, or rayon.

10. The carpet of claim 1, wherein thermoplastic polymer layer comprises a single layer.

11. The carpet of claim 1, wherein the thermoplastic polymer layer comprises two or more layers, with each layer comprising at least one thermoplastic polymer.

12. The carpet of claim 1, wherein the thermoplastic polymer layer comprises one or more of: styrene butadiene latex compounds, acrylic modified styrene butadiene compounds, urethane compounds, polyvinyl chloride, ULDPE, LDPE, MDPE, HDPE, SLEP, HBLEP, ethylene acrylic acid copolymer, ethylene ethyl acrylate copolymer, polystyrene, polypropylene, polyester, polybutylene, polyamide, polycarbonate, rubbers, ethylene propylene polymers, ethylene styrene polymers, styrene block copolymers, vulcanates, or vinyl acetate ethylene.

13. The carpet of claim 12, wherein the thermoplastic polymer comprises one or more of: ULDPE, LDPE, MDPE, HDPE, SLEP, HBLEP, or EVA.

14. The carpet of claim 1, wherein the thermoplastic polymer layer further comprises an additive comprising one or more of: flame retardants, antioxidants, antimicrobials, smoke suppressants, wetting agents, or frothing aids.

15. The carpet of claim 1, wherein the thermoplastic polymer layer is present on the carpet at from about less than or equal to 10 ounces by weight per square yard of carpet.

16. The carpet of claim 15 wherein the thermoplastic polymer layer is present on the carpet at from about 4 to about 10 ounces by weight per square yard of carpet.

17. The carpet of claim 15 wherein the thermoplastic polymer layer is present on the carpet at from about 0.5 to about 4 ounces by weight per square yard of carpet.

18. The carpet of claim 1 wherein the carpet is in the form of a carpet tile.

19. A method of manufacturing a carpet having a thermoplastic polymer layer wherein the method comprises:
a) tufting a yarn into a primary backing, wherein the primary backing has a face side and a back side;
b) adhesively affixing the yarn to the primary backing with an adhesive;
c) providing a woven secondary backing having a first side and a second side;
d) attaching directly or indirectly the first side of the secondary backing to the back side of the primary backing; and
e) applying a thermoplastic polymer layer to the second side of the secondary backing under conditions suitable to melt bond the thermoplastic polymer layer to the secondary backing.

20. The method of claim 19, wherein the carpet exhibits reduced moisture permeability, as compared to a carpet not having the thermoplastic polymer layer.

21. The method of claim 19, wherein the carpet exhibits a decreased coefficient of friction on a side opposite the yarn, as compared to a carpet not having the thermoplastic polymer layer.

22. The method of claim 19, wherein the thermoplastic polymer layer is applied via extrusion.

23. The method of claim 19, wherein the thermoplastic polymer layer is applied via film lamination.

24. The method of claim 19, wherein the yarn comprises one or more of: wool, cotton, nylon, acrylic, polytrimethylenetheraphthalate, polyester, or polypropylene.

25. The method of claim 19, wherein the adhesive comprises one or more of: latex, polyethylene, ethylene acrylic acid, carboxylated SBR, ethylene vinyl acetate (EVA), polyvinyl chloride (PVC), or polyurethane.

26. The method of claim 19, wherein the adhesive does not comprise a hot melt.

27. The method of claim 19, wherein the primary backing comprises one or more of: jute, wool, polypropylene, polyethylene, polyamide, polyesters, or rayon.

28. The method of claim 19 further comprising attaching an intermediate layer between the back side of the primary backing and the first side of the secondary backing wherein the intermediate layer comprises one or more of: fiberglass, foam, or wire stabilizer mesh.

29. The method of claim 19, wherein the secondary backing comprises one or more of: jute, wool, polypropylene, polyethylene, polyamide, polyesters, or rayon.

30. The method of claim 19, wherein thermoplastic polymer layer comprises a single layer.

31. The method of claim 19, wherein the thermoplastic polymer layer comprises two or more layers, with each layer comprising at least one thermoplastic polymer.

32. The method of claim 19, wherein the thermoplastic polymer layer comprises one or more of: styrene butadiene latex compounds, acrylic modified styrene butadiene compounds, urethane compounds, polyvinyl chloride, ULDPE, LDPE, MDPE, HDPE, SLEP, HBLEP, ethylene acrylic acid copolymer, ethylene ethyl acrylate copolymer, polystyrene, polypropylene, polyester, polybutylene, polyamide, polycarbonate, rubbers, ethylene propylene polymers, ethylene styrene polymers, styrene block copolymers, vulcanates, or vinyl acetate ethylene.

33. The method of claim 32, wherein the thermoplastic polymer comprises one or more of: ULDPE, LDPE, MDPE, HDPE, SLEP, HBLEP, or EVA.

34. The method of claim 19, wherein the thermoplastic polymer layer further comprises an additive comprising one or more of: flame retardants, antioxidants, antimicrobials, smoke suppressants, wetting agents, or frothing aids.

35. The method of claim 19, wherein the thermoplastic polymer layer is present on the carpet at from about less than or equal to 10 ounces by weight per square yard of carpet.

36. The method of claim 35 wherein the thermoplastic polymer layer is present on the carpet at from about 4 to about 10 ounces by weight per square yard of carpet.

37. The method of claim 35 wherein the thermoplastic polymer layer is present on the carpet at from about 0.5 to about 4 ounces by weight per square yard of carpet.

38. The method of claim 31 wherein the thermoplastic polymer layer comprises a first polymer layer having first and second sides, wherein the first side of the first polymer layer is adjacent to the secondary backing, and a second polymer layer is adjacent to the second side of the first polymer layer and wherein the first polymer layer has a lower melt temperature than the second polymer layer.

39. The method of claim 19 further comprising cutting the carpet into carpet tiles.
